(19) United States
(12) Patent Application Publication
(10) Pub. No.: US 2026/0340704 A1
(43) Pub. Date: Oct. 29, 2026

(54) INTERACTION METHOD AND APPARATUS, ELECTRONIC DEVICE, STORAGE MEDIUM, AND PROGRAM PRODUCT

(71) Applicant: Beijing Youzhuju Network Technology Co., Ltd., Beijing (CN)

(72) Inventors: Junlin CAI, Beijing (CN); Haoran LI, Beijing (CN); Jin BAI, Beijing (CN)

(21) Appl. No.: 19/660,199

(22) Filed: Apr. 27, 2026

(30) Foreign Application Priority Data
Apr. 29, 2025 (CN) 202510560658.6

(51) Int. Cl. G06Q 30/0601; G06F 3/0483; G06F 3/04842; G06T 11/60

(52) U.S. Cl. CPC G06Q 30/0631; G06F 3/0483; G06F 3/04842; G06T 11/60; G06T 2200/24

(57) ABSTRACT

The present application discloses an interaction method, an apparatus, an electronic device, a storage medium and a program product, which relate to the field of data processing technology. The method includes: displaying picture-text recommendation information and an interaction control on a first page, the picture-text recommendation information including at least one piece of recommendation picture-text, the interaction control being associated with an interactive animation and a target recommendation picture-text in the at least one piece of recommendation picture-text; and in response to a trigger instruction for the interaction control, displaying the target recommendation picture-text on the first page, and superimposing and displaying the interactive animation on the target recommendation picture-text, the interactive animation being used to trigger display of recommendation content.

### CROSS REFERENCE TO RELATED APPLICATIONS

This application is based on and claims priority of CN application with application No. 202510560658.6 filed on April 29, 2025, the entire disclosure of which is hereby incorporated by reference.

### TECHNICAL FIELD

The present disclosure relates to the field of data processing technology, and in particular, to an interaction method, an apparatus, an electronic device, a storage medium and a program product.

### BACKGROUND

With the development of self-media applications, more and more brand owners will recommend products or brands through self-media applications. How to improve the recommendation effect of recommended content has become an urgent problem to be solved.

### SUMMARY

In view of this, the present disclosure provides an interaction method, an apparatus, an electronic device, a storage medium and a program product to solve the problem of recommendation of recommended content.

In a first aspect, the present disclosure provides an interaction method, including:
displaying picture-text recommendation information and an interaction control on a first page, the picture-text recommendation information including at least one piece of recommendation picture-text, the interaction control being associated with an interactive animation and a target recommendation picture-text in the at least one piece of recommendation picture-text; and
in response to a trigger instruction for the interaction control, displaying the target recommendation picture-text on the first page, and superimposing and displaying the interactive animation on the target recommendation picture-text, the interactive animation being used to trigger display of recommendation content.

In a second aspect, the present disclosure provides an interaction apparatus, including:
a first display module, configured to display picture-text recommendation information and an interaction control on a first page, the picture-text recommendation information including at least one piece of recommendation picture-text, the interaction control being associated with an interactive animation and a target recommendation picture-text in the at least one piece of recommendation picture-text; and
a second display module, configured to, in response to a trigger instruction for the interaction control, display the target recommendation picture-text on the first page, and superimpose and display the interactive animation on the target recommendation picture-text, the interactive animation being used to trigger display of recommendation content.

In a third aspect, the present disclosure provides an electronic device, including a memory and a processor, the memory and the processor are communicatively connected to each other, the memory stores computer instructions, and the processor executes the computer instructions to implement the interaction method according to the above first aspect or any corresponding implementation thereof.

In a fourth aspect, the present disclosure provides a computer-readable storage medium, the computer-readable storage medium stores computer instructions, and the computer instructions are used to cause a computer to implement the interaction method according to the above first aspect or any corresponding implementation thereof.

In a fifth aspect, the present disclosure provides a computer program product, including computer instructions, the computer instructions are used to cause a computer to implement the interaction method according to the above first aspect or any corresponding implementation thereof.

In the interaction method provided by an embodiment of the present disclosure, through the design of the interaction control, an interaction channel for interacting with the picture-text recommendation information may be provided to attract the user to interact with the interaction control. The target recommendation picture-text is displayed and the interactive animation is superimposed and displayed in response to the trigger instruction for the interaction control.

### BRIEF DESCRIPTION OF THE DRAWINGS

In order to more clearly describe the technical solutions in the specific embodiments of the present disclosure or in the related art, the following will briefly introduce the drawings that need to be used in the description of the specific embodiments or the related art. Obviously, the drawings in the following description are some embodiments of the present disclosure. For those of ordinary skill in the art, other drawings may be obtained based on these drawings without creative efforts.

FIG. 1 is a schematic diagram of an application scenario according to an embodiment of the present invention;

FIG. 2 is a schematic flowchart of an interaction method according to an embodiment of the present disclosure;

FIG. 3 is a schematic diagram of a progress bar according to an embodiment of the present disclosure;

FIG. 4 is a schematic diagram of another progress bar according to an embodiment of the present disclosure;

FIG. 5 is a schematic diagram of an interactive animation according to an embodiment of the present disclosure;

FIG. 6 is a schematic diagram of another interactive animation according to an embodiment of the present disclosure;

FIG. 7 is a schematic diagram of a movable control according to an embodiment of the present disclosure;

FIG. 8 is a schematic diagram of another movable control according to an embodiment of the present disclosure;

FIG. 9 is a schematic diagram of a first page according to an embodiment of the present disclosure;

FIG. 10 is a schematic flowchart of another interaction method according to an embodiment of the present disclosure;

FIG. 11 is a design framework of an interaction method according to an embodiment of the present disclosure;

FIG. 12 is a structural block diagram of an interaction apparatus according to an embodiment of the present disclosure; and

FIG. 13 is a structural block diagram of an electronic device according to an embodiment of the present disclosure.

### DETAILED DESCRIPTION OF EMBODIMENTS

In order to make the purpose, technical solutions and advantages of the embodiments of the present disclosure clearer, the technical solutions in the embodiments of the present disclosure will be described clearly and completely below in combination with the drawings in the embodiments of the present disclosure. Obviously, the described embodiments are part of the embodiments of the present disclosure, but not all of the embodiments. Based on the embodiments in the present disclosure, all other embodiments obtained by those skilled in the art without creative efforts belong to the scope of protection of the present disclosure.

It may be understood that before using the technical solutions disclosed in the embodiments of the present disclosure, the user should be informed of the type, range of use, use scenarios, etc. of personal information involved in the present disclosure and obtain the user’s authorization in an appropriate manner in accordance with relevant laws and regulations.

For example, in response to receiving an active request from a user, prompt information is sent to the user to clearly prompt the user that the requested operation will require access to and use of the user’s personal information. In this way, the user may independently choose whether to provide personal information to software or hardware such as an electronic device, an application, a server or a storage medium that perform the operations of the technical solutions of the present disclosure based on the prompt information.

As an optional but non-limiting implementation, in response to receiving an active request from a user, the manner of sending prompt information to the user may be, for example, a pop-up window, and the prompt information may be presented in the pop-up window in text. In addition, the pop-up window may also carry a selection control for the user to choose whether to “agree” or “disagree” to provide personal information to the electronic device.

It may be understood that the above process of notifying and obtaining user authorization is only illustrative and does not limit the implementation of the present disclosure, and other methods that satisfy relevant laws and regulations may also be applied to the implementation of the present disclosure.

It may be understood that the data involved in the technical solution (including but not limited to the data itself, acquisition or use of the data) should comply with the requirements of corresponding laws, regulations and related provisions.

At present, brand owners will recommend products or brands through videos. However, for some brand owners, it is difficult to produce videos, so they will choose to place static picture-text content to improve the exposure of recommended content. However, due to the lack of interactivity of the static picture-text content, the recommendation effect of the recommended content is not good.

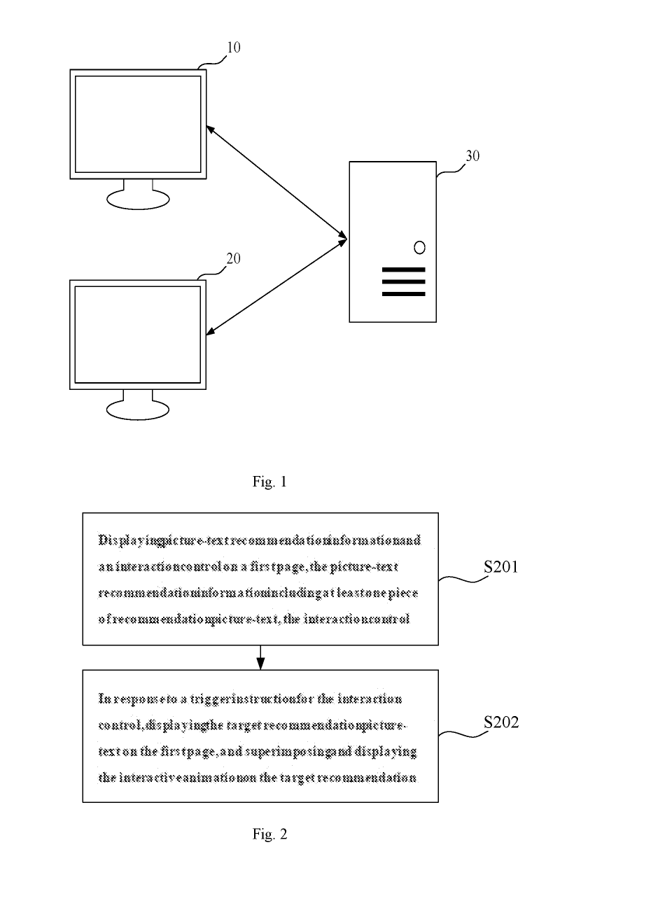

As an optional application scenario of an embodiment of the present invention, as shown in FIG. 1, FIG. 1 is an optional schematic diagram of an application scenario according to an embodiment of the present disclosure. The entire interaction scenario includes a client 10, a client 20, and a server 30. Users such as brand owners may upload recommendation picture-text through the client 10 and generate a target video based on the recommendation picture-text. Then, the client 10 uploads the target video to the server 30. The server 30 pushes the target video to the client 20. The client 20 displays the received target video, and a user of the client 20 may interact with the target video displayed by the client 20.

In view of this, according to an embodiment of the present disclosure, an embodiment of an interaction method is provided. It should be noted that the steps shown in the flowcharts of the drawings may be executed in a computer system such as a set of computer executable instructions, and although a logical order is shown in the flowcharts, in some cases, the steps shown or described may be executed in an order different from that here.

In this embodiment, an interaction method is provided, which may be used for an electronic device, such as the client 20 installed on the electronic device. FIG. 2 is a schematic flowchart of an interaction method according to an embodiment of the present disclosure. As shown in FIG. 2, the flow includes the following steps:

Step S201, displaying picture-text recommendation information and an interaction control on a first page, the picture-text recommendation information including at least one piece of recommendation picture-text, the interaction control being associated with an interactive animation and a target recommendation picture-text in the at least one piece of recommendation picture-text.

Specifically, a display sequence of recommendation picture-text may be preset, and the recommendation picture-text is displayed on the first page according to the display sequence. Alternatively, the picture-text recommendation information in a video form is generated using the at least one piece of recommendation picture-text. For example, the picture-text recommendation information in the video form is generated by setting the display sequence of each piece of recommendation picture-text and the display time of each piece of recommendation picture-text.

The above recommendation picture-text may be uploaded by the user through an upload interface provided by the client 10, or may be generated by the user through a picture-text production interface provided by the client 10, and the acquisition method of the recommendation picture-text is not limited here.

Optionally, an interaction prompt is displayed in a corresponding display area of the interaction control, and the interaction prompt is used to indicate an interaction with the interaction control.

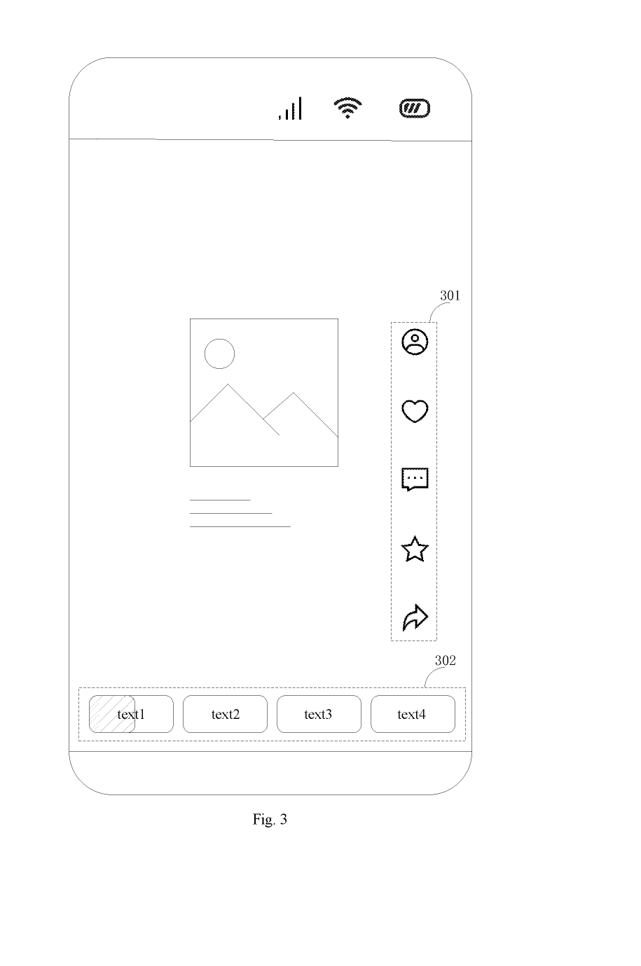

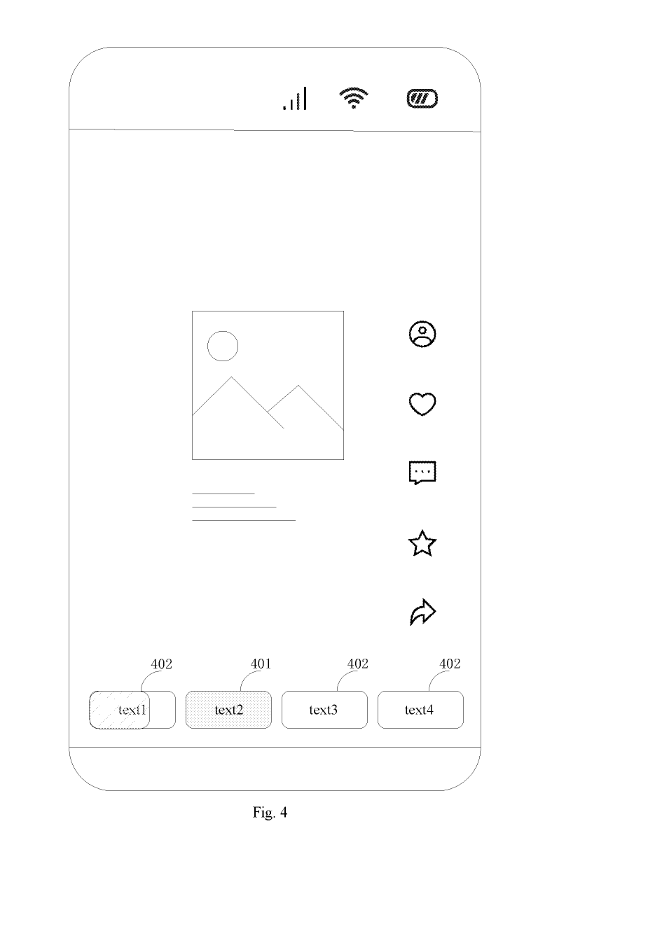

Specifically, as shown in FIG. 3, at least one function control 301 is further displayed on the first page, for example, an object control (such as a user avatar), a “like” control, a comment control, a collection control, a sharing control, and the like. The user may access a user page corresponding to the picture-text recommendation information, mark the picture-text recommendation information as liked, comment on the picture-text recommendation information, collect the picture-text recommendation information, share the picture-text recommendation information, etc. through interaction with the function control.

Step S202, in response to a trigger instruction for the interaction control, displaying the target recommendation picture-text on the first page, and superimposing and displaying the interactive animation on the target recommendation picture-text, the interactive animation being used to trigger display of recommendation content.

Specifically, the target recommendation picture-text and the interactive animation associated with the interaction control are preset, and in the case where the interaction control is triggered, the associated target recommendation picture-text is displayed on the first page, and the interactive animation is superimposed and displayed on the target recommendation picture-text.

Optionally, the user may upload interactive elements through the upload interface provided by the client 10, and the client 10 generates the interactive animation based on the interactive elements uploaded by the user. At the same time, the user also needs to configure the recommendation content associated with the interactive animation, so that the client 10 associates the interactive animation with the recommendation content. Alternatively, the client 10 provides some selection styles of interactive animation for the user to select the interactive animation associated with the interaction control, and associates the interactive animation with the recommendation content.

In the interaction method provided by this embodiment, through the design of the interaction control, an interaction channel for interacting with the picture-text recommendation information may be provided to attract the user to interact with the interaction control. The target recommendation picture-text is displayed and the interactive animation is superimposed and displayed in response to the trigger instruction for the interaction control, therefore, the interactivity of the display of the picture-text recommendation information may be further improved by using the interactive animation, so as to improve the user interaction rate, which in turn helps to improve the trigger display of the recommendation content, thereby improving the recommendation effect of the recommendation content.

The beneficial effects of the interaction apparatus, the electronic device, the storage medium and the program product correspond to the beneficial effects of the interaction method, and are not repeated here.

In some optional implementations, the interaction control includes a first progress bar in a first display style, the first page is further configured to display a second progress bar in a second display style, and the first progress bar and the second progress bar correspond to a position of the at least one piece of recommendation picture-text in the picture-text recommendation information.

Exemplarily, as shown in FIG. 3, a display progress bar of the picture-text recommendation information may be divided into progress bars corresponding to the recommendation picture-text, for example, a first progress bar and a second progress bar, according to the position of the recommendation picture-text in the picture-text recommendation information. One progress bar may correspond to one or more pieces of recommendation picture-text, which may be adjusted according to the actual situation.

In order to facilitate the user to interact with the first progress bar/the second progress bar, in the interaction method of the present disclosure, the first progress bar and the second progress bar are enlarged in a different manner, thereby attracting the user to notice the first progress bar and interact with the first progress bar, such as “clicking” or “sliding” the first progress bar. At the same time, the progress bar enlarged in a different manner may also facilitate the user to click the progress bar.

Optionally, corresponding interaction prompts are displayed in corresponding display areas of the first progress bar and the second progress bar, and the interaction prompts of the first progress bar and the second progress bar are related to picture-text information of associated recommendation picture-text. For example, as shown in FIG. 3, in FIG. 3, it is assumed that the picture-text recommendation information includes four pieces of recommendation picture-text, and four progress bars 302 are divided according to the position of the recommendation picture-text in the picture-text recommendation information. Corresponding interaction prompts are displayed in corresponding display areas of each of the progress bars 302, for example, text1 is displayed in the first progress bar 302, text2 is displayed in the second progress bar 302, text3 is displayed in the third progress bar 302, and text4 is displayed in the fourth progress bar 302. The interaction prompt displayed in each progress bar 302 is related to the picture-text information of the recommendation picture-text associated with the progress bar 302. For example, the first progress bar 302 is associated with the first piece of recommendation picture-text, and thus text1 is related to the picture-text information of the first piece of recommendation picture-text. For example, a theme of the first piece of recommendation picture-text is “good product”, and thus text1 is “good product”.

Optionally, the first display style and the second display style correspond to a same progress bar height, and the first display style and the second display style correspond to different progress bar fill styles. For example, the first display style corresponds to a highlighted fill for the progress bar, and the second display style corresponds to a white fill for the progress bar.

Alternatively, the first display style and the second display style correspond to different progress bar line styles or progress bar shapes, and the first display style and the second display style may be adjusted according to the actual situation.

Exemplarily, assuming that the second progress bar is a first progress bar 401 and the other progress bars are second progress bars 402, as shown in FIG. 4, the first progress bar 401 and the second progress bars 402 may be filled with different colors. Since the display style of the first progress bar 401 is different from that of the second progress bars 402, the user may be prompted to notice the first progress bar 401 and interact with the first progress bar 401.

It should be noted that in a process of the client 20 displaying the recommendation picture-text in the picture-text recommendation information, the progress bar corresponding to each piece of recommendation picture-text will change with the display time/display state of the corresponding recommendation picture-text.

In the interaction method provided by this embodiment, the first progress bar of the target recommendation picture-text is used as the interaction control, and different display styles are adopted for the first progress bar of the target recommendation picture-text and the second progress bars of other recommendation picture-text. Therefore, the user may be attracted to notice the first progress bar and interact with the first progress bar, thereby improving the interaction rate of the first progress bar.

In some optional implementations, in the case where the interaction control includes the first progress bar, the above step S202 includes:

Step a1, in a case where a trigger timing of the first progress bar is satisfied, generating a trigger instruction for the first progress bar.

In some optional implementations, the trigger timing includes at least one of the following: display time of the picture-text recommendation information reaching a display timing of the target recommendation picture-text corresponding to the first progress bar; and detecting an interaction operation for the first progress bar.

Specifically, the client 20 displays the recommendation picture-text in the picture-text recommendation information based on a position of the recommendation picture-text in the picture-text recommendation information and a display period corresponding to the recommendation picture-text. In the case where the display time of the picture-text recommendation information reaches the display timing of the target recommendation picture-text corresponding to the first progress bar, the trigger instruction for the first progress bar is generated.

The display timing is a display period or a start display moment of the target recommendation picture-text in the display process of the picture-text recommendation information.

Specifically, in the case where the client 20 detects the interaction operation for the first progress bar, the trigger instruction for the first progress bar is generated.

For example, in the case where the user “clicks” or “slides” the first progress bar, the client 20 generates the trigger instruction for the first progress bar.

Step a2, in response to the trigger instruction for the first progress bar, displaying the target recommendation picture-text on the first page, and superimposing and displaying the interactive animation on the target recommendation picture-text.

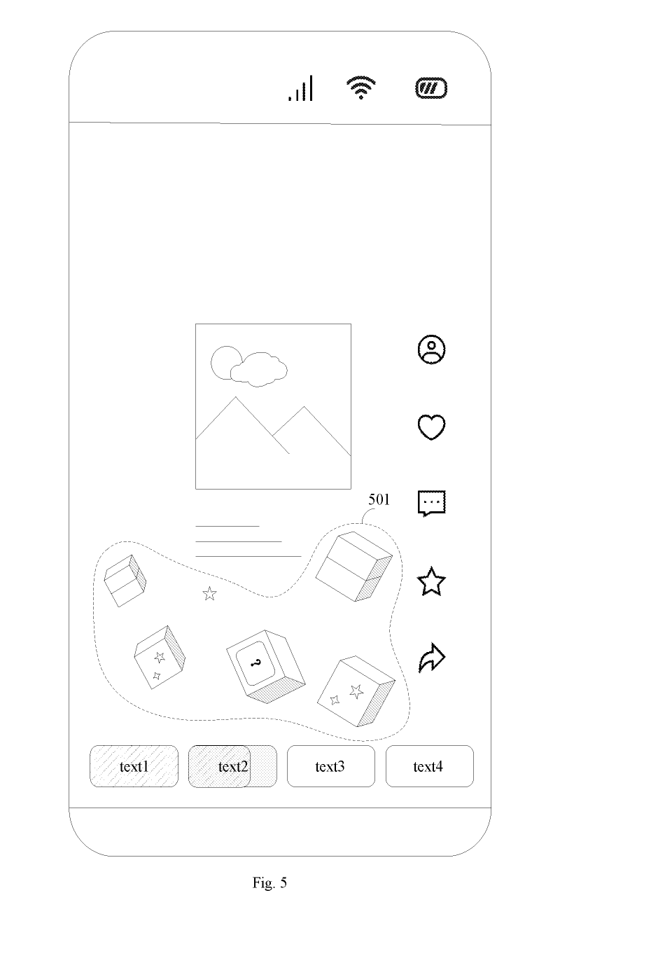

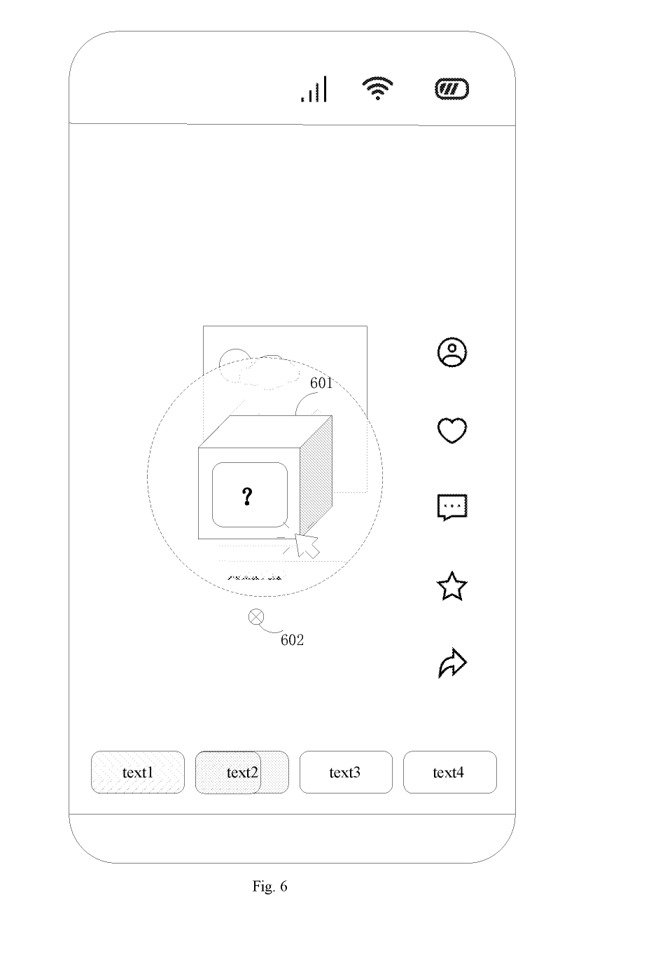

Exemplarily, as shown in FIG. 5, taking the second progress bar as the first progress bar as an example, in the case where the picture-text recommendation information is displayed to a progress point of the second progress bar, or the user “clicks” the second progress bar, the target recommendation picture-text associated with the second progress bar is displayed on the first page, and an interactive animation 501 is superimposed and displayed on the target recommendation picture-text. Further, as shown in FIG. 6, the interactive animation includes an interactive control 601. In a last frame of the interactive animation, the interactive control 601 may be highlighted, and an interaction prompt corresponding to the interactive control 601 may be displayed, for example, “click the gift box” as shown in FIG. 6, thereby attracting the user to interact with the interactive control 601 to trigger the display of the recommendation content.

In the interaction method provided by this embodiment, the target recommendation picture-text corresponding to the first progress bar is specially processed, and in the case where the first progress bar is triggered, the target recommendation picture-text is displayed and the interactive animation is superimposed and displayed. Therefore, the user may be attracted to participate in the interaction by using the interactive animation, thereby triggering the display of the recommendation content, and further improving the recommendation effect of the recommendation content.

In some optional implementations, the interaction control includes a movable control, and a trigger instruction of the movable control is generated based on moving the movable control from a first position to a second position, or generated based on moving the movable control in a preset direction.

Optionally, an interaction prompt of the movable control is displayed in a corresponding display area of the movable control, and the interaction prompt is used to indicate an interaction with the movable control.

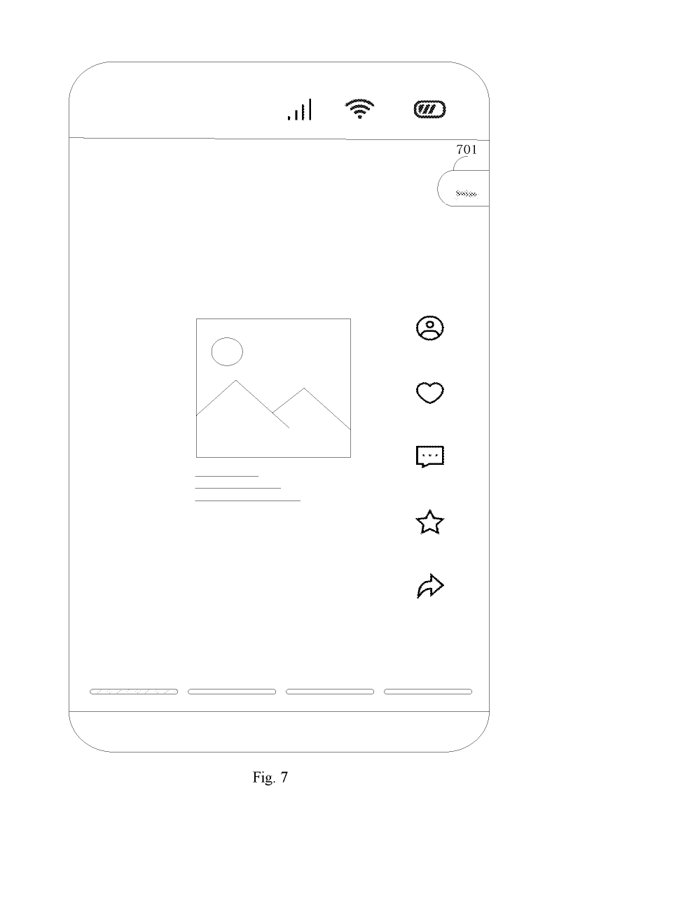

For example, as shown in FIG. 7, an interaction prompt “swipe left” is displayed in a corresponding display area of a movable control 701, and the user may “swipe left” the movable control 701 to generate the trigger instruction for the movable control.

Optionally, the first position may be a right edge area of the first page, and the second position may be a display area on a left side of the first position. Alternatively, the preset direction is a left direction. The interaction manner of the movable control may be adjusted according to the actual situation.

Optionally, the movable control is in a form of bubble, and may also be in a form of label, which is not limited here.

Further, the interaction method of the present disclosure further includes: displaying a moving animation of the movable control on the first page, the moving animation being used to prompt the interaction with the movable control.

In the interaction method provided by this embodiment, the movable control is used as the interaction control, and the movable control is triggered by a moving limit of the movable control. Therefore, the movable control may be used to prompt the user to interact with the movable control, thereby improving the user interaction rate.

In some optional implementations, in the case where the interaction control includes the movable control, the above step S202 includes:

Step b1, in response to a target interaction operation for the movable control, generating the trigger instruction for the movable control, the target interaction operation including moving the movable control from the first position to the second position, or moving the movable control in the preset direction.

In some optional implementations, the above step b1 includes: in response to the target interaction operation for the movable control, in a case where an interaction duration of the target interaction operation reaches a first preset duration, generating the trigger instruction for the movable control.

Optionally, the first preset duration is 3s, which may be adjusted according to an actual application, for example, 4s, etc.

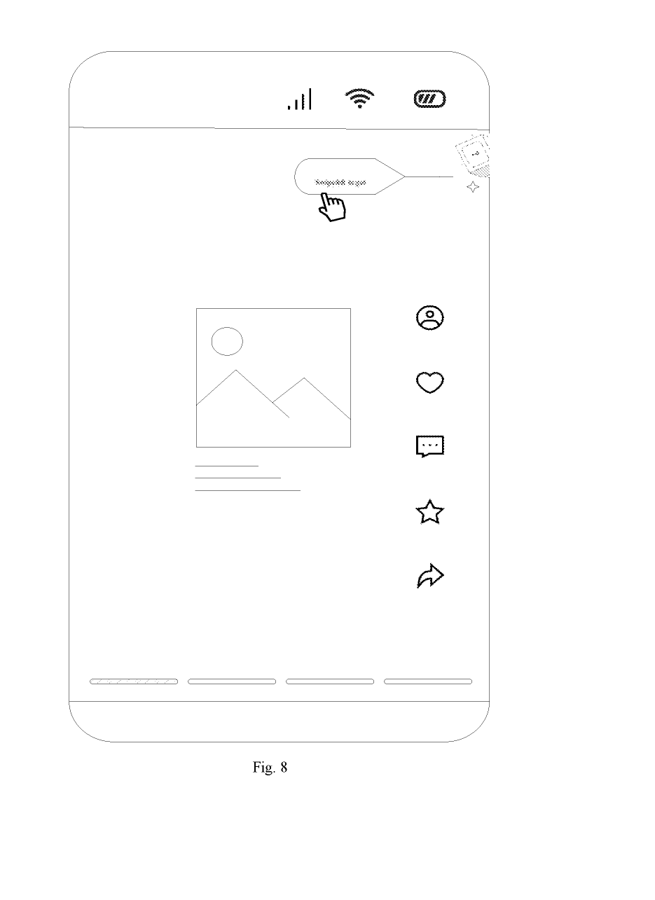

Further, an interaction countdown is displayed in the corresponding display area of the movable control, a start duration of the interaction countdown is the first preset duration, and the interaction countdown decreases with an increase of the interaction duration. For example, as shown in FIG. 8, in the case where the user moves the movable control in the preset direction (such as the left direction), the interaction countdown (such as 3s) is displayed in the corresponding display area of the movable control, and in the case where the interaction countdown reaches zero, the trigger instruction for the movable control is generated.

In the interaction method provided by this embodiment, the trigger instruction for the movable control is generated only when the interaction duration of the target interaction operation reaches the first preset duration. Therefore, the movable control may be prevented from being triggered by misoperation, thereby improving the interaction effect.

Step b2, in response to the trigger instruction for the movable control, displaying the target recommendation picture-text on the first page, and superimposing and displaying the interactive animation on the target recommendation picture-text.

It should be noted that for the display of the target recommendation picture-text and the interactive animation, reference may be made to the relevant description of the above step a2, which will not be repeated here.

Further, as shown in FIG. 8, the interaction method of the present disclosure further includes: in response to the target interaction operation for the movable control, displaying a moving trail of the movable control, and displaying some interactive elements in the interactive animation at a start position of the moving trail.

In the interaction method provided by this embodiment, the movable control is used to attract the user to interact with the movable control, and in the case where the movable control is triggered, the user is attracted to participate in the interaction by using the interactive animation. Therefore, the interaction effect of the display of the picture-text recommendation information may be improved, which in turn helps to improve the interaction rate and recommendation effect of the recommendation content.

In some optional implementations, the interaction method of the present disclosure further includes: in a case where a display duration of the interactive animation reaches a second preset duration and all interaction controls are triggered, switching the first progress bar in the interaction controls and the second progress bar in the first page to a third display style for display, and/or hiding the movable control in the interaction controls, a height of the first progress bar and a height of the second progress bar before switching being greater than a height corresponding to the third display style.

Specifically, in the case where the interaction control includes the first progress bar, in the case where the display duration of the interactive animation reaches the second preset duration and all the interaction controls are triggered, the first progress bar and the second progress bar are switched to the third display style for display.

Specifically, in the case where the interaction control includes the movable control, in the case where the display duration of the interactive animation reaches the second preset duration and all the interaction controls are triggered, the movable control is hidden.

It should be noted that in practical applications, there may be multiple interaction controls, and the target recommendation picture-text and the interactive animation associated with each interaction control may be the same or different. The recommendation content associated with each interactive animation may be the same or different, for example, interactive animation animation1 is associated with the recommendation content of the product, and interactive animation animation2 is associated with the recommendation content of the brand owner. In order to avoid that after the interactive animation triggered previously is displayed, the interaction control is switched to the target display state (such as the first progress bar in the third display style and the movable control in the hidden state), so that the interactive animation and the recommendation content associated with other interaction controls that have not been triggered have no chance to be displayed, because it is necessary to wait until the display duration of the interactive animation reaches the second preset duration and all the interaction controls are triggered, switch the interaction control to the target display state.

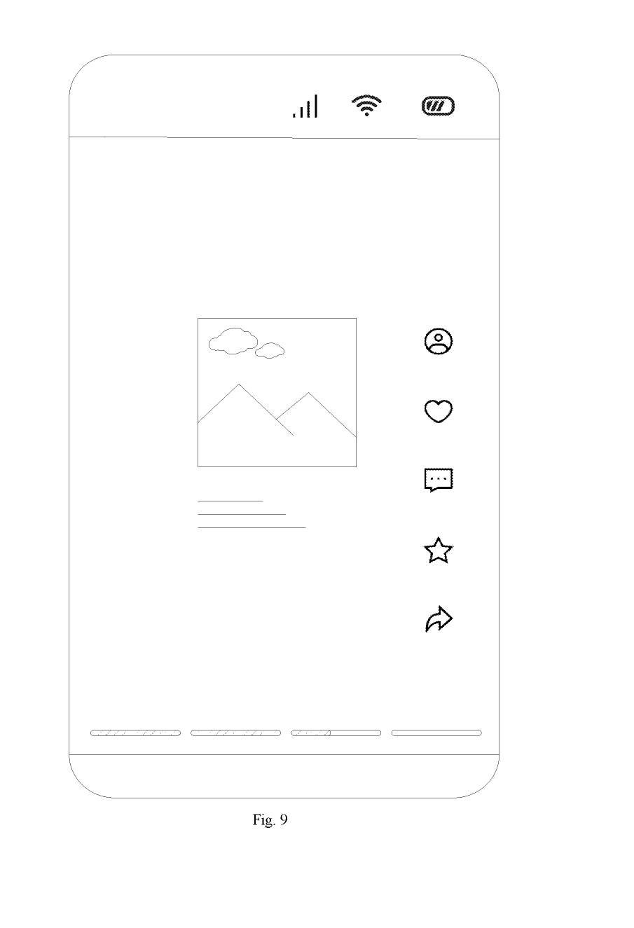

Exemplarily, as shown in FIG. 9, in the case where the display duration of the interactive animation reaches the second preset duration and all the interaction controls are triggered, the first progress bar and the second progress bar are displayed in the third display style, and the movable control and the interaction prompt are both hidden. It may be seen from FIG. 9 that, compared with the first progress bar in the first display style and the second progress bar in the second display style shown in FIG. 3 to FIG. 6, the first progress bar and the second progress bar in the third display style are restored to a normal height, and the height of the progress bar is smaller than the height of the progress bar in the first display style and the second display style.

In some optional implementations, the interactive animation includes an interactive control, and the interactive control is used to trigger the display of the recommendation content. The interaction method of the present disclosure further includes: in response to an interaction operation for the interactive control, displaying the recommendation content on a second page.

Specifically, the interactive control is associated with a page link of the second page where the recommendation content is located, and the page link is acquired in response to the interaction operation for the interactive control. The second page is accessed and displayed through the page link, and the recommendation content is displayed on the second page.

Optionally, the recommendation content includes information and a product of a brand owner, and the like.

Optionally, the interactive control is in a form of gift box or a form of card. In addition, other forms of interactive controls may be selected according to the actual situation, which is not limited here.

If the interactive control is in the form of gift box, the interaction operation for the interactive control includes “opening the gift box”. If the interactive control is in the form of card, the interaction operation for the interactive control includes “scratching the card” and “flipping the card”, etc.

In some optional implementations, as shown in FIG. 6, a close control 602 is displayed in a corresponding display area of the interactive control. The interaction method of the present disclosure further includes: in response to an interaction operation for the close control, closing the display of the interactive animation.

Further, after closing the display of the interactive animation, the interaction method of the present disclosure further includes: switching the interaction control to a target display state.

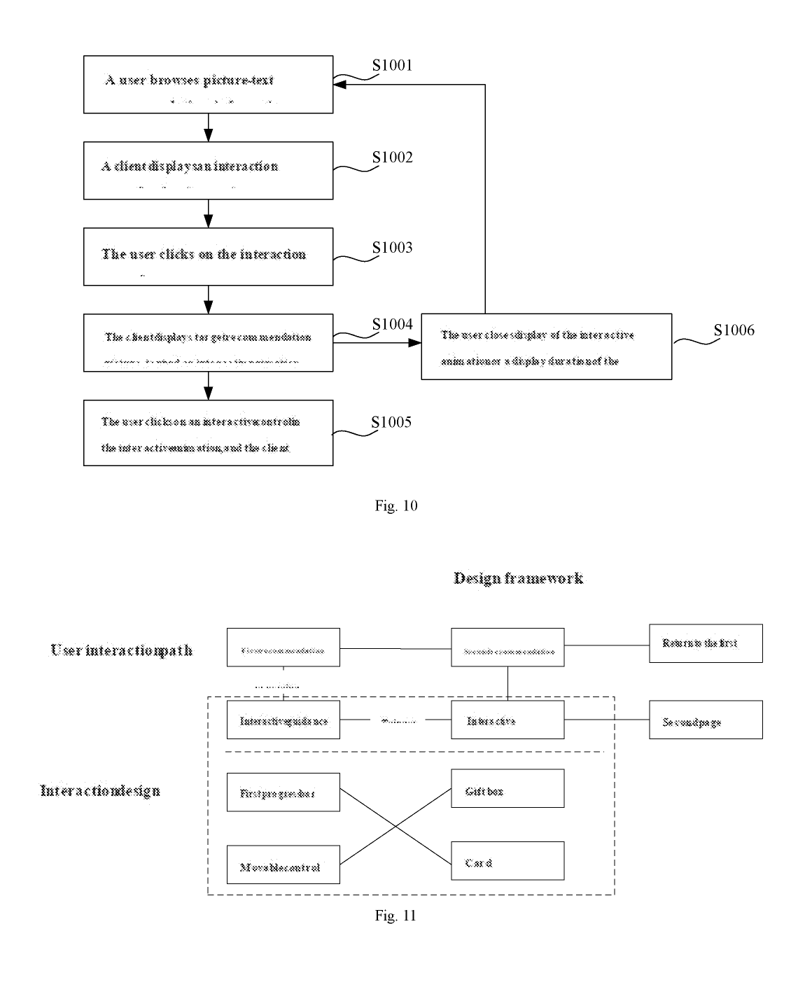

As a specific application example, as shown in FIG. 10, the interaction method of the present disclosure mainly includes the following steps:

Step S1001, a user browses the picture-text recommendation information.

Step S1002, a client displays the interaction control and an interaction prompt.

Step S1003, the user clicks on the interaction control.

Step S1004, the client displays the target recommendation picture-text and the interactive animation associated with the interaction control.

Step S1005, the user clicks on the interactive control in the interactive animation, and the client jumps to the second page corresponding to the recommendation content, and this interaction process ends.

Step S1006, if the user closes the display of the interactive animation or the display duration of the interactive animation reaches the second preset duration, the method goes back to step S1001.

As a specific application example, the client 10 is installed on a computer, and a brand owner uploads or produces recommendation picture-text through the client 10, and generates picture-text recommendation information by using the recommendation picture-text, for example, sets a display sequence and a display time of the recommendation picture-text to generate a recommendation video (i.e., the picture-text recommendation information). Then, the client 10 sends the recommendation video to the server 30. A user installs the client 20 on a mobile phone, and the server 30 pushes the recommendation video to the client 20 through a preset recommendation configuration, and the client 20 displays the recommendation video and an interaction control by using the interaction method of the present disclosure. The user may interact with the interaction control to cause the client 20 to display target recommendation picture-text corresponding to the interaction control and display an interactive animation on the target recommendation picture-text. The user may interact with the interactive animation to cause the client 20 to jump to a page corresponding to recommendation content. The interaction method of the present disclosure may use the interaction control to attract the user to interact, thereby increasing the interaction rate of the user, and use the interactive animation to improve the interaction effect, thereby improving the recommendation effect of the recommendation content.

It should be noted that, as shown in FIG. 11, a design framework of the interaction solution of the present disclosure is as follows: for a user interaction path, the client 20 displays recommendation picture-text in sequence on a first page according to a display sequence of the recommendation picture-text in picture-text recommendation information, for example, first recommendation picture-text, second recommendation picture-text, and the like. When displaying the first recommendation picture-text, the client 20 also displays an interaction control, for example, the above-mentioned first progress bar and the movable control. Assuming that the interaction control is associated with the second recommendation picture-text, the user may perform an interaction operation with the interaction control, such as “clicking” the interaction control, to cause the client 20 to display the second recommendation picture-text and an interactive animation on the first page. The interactive animation includes an interactive control associated with recommendation content (such as recommendation content of a product or a brand owner), such as an interactive control such as a gift box and a card. The user may “click” the interactive control and participate in the interaction to cause the client 20 to jump to a second page corresponding to the recommendation content. A return control is displayed on the second page, and the user may click the return control to return to the first page to continue displaying remaining recommendation picture-text in the picture-text recommendation information.

It may be seen that the interaction method of the present disclosure may output a variety of different guidance forms under interactive guidance, such as a progress bar prompt or a movable control prompt, and may extend a variety of different interaction methods in the interactive animation, such as “opening a gift box”, “scratching a card”, “flipping a card”, and the like. The form of interactive guidance and the interaction manner of the interactive animation may be combined with each other to output more interactive styles with high interaction rate. Therefore, in the interaction method of the present disclosure, in the case where it is difficult for the user to produce a high-quality recommendation video, the user only needs to provide limited recommendation picture-text, and the interaction method of the present disclosure may be used to improve the user interaction rate, thereby improving the recommendation effect of the recommendation content to a certain extent.

In this embodiment, an interaction apparatus is further provided, and the apparatus is used to implement the above embodiments and preferred implementations, which will not be repeated here. As used below, the term “module” may implement a combination of software and/or hardware for a predetermined function. Although the apparatus described in the following embodiments is preferably implemented in software, implementation in hardware, or a combination of software and hardware is also possible and contemplated.

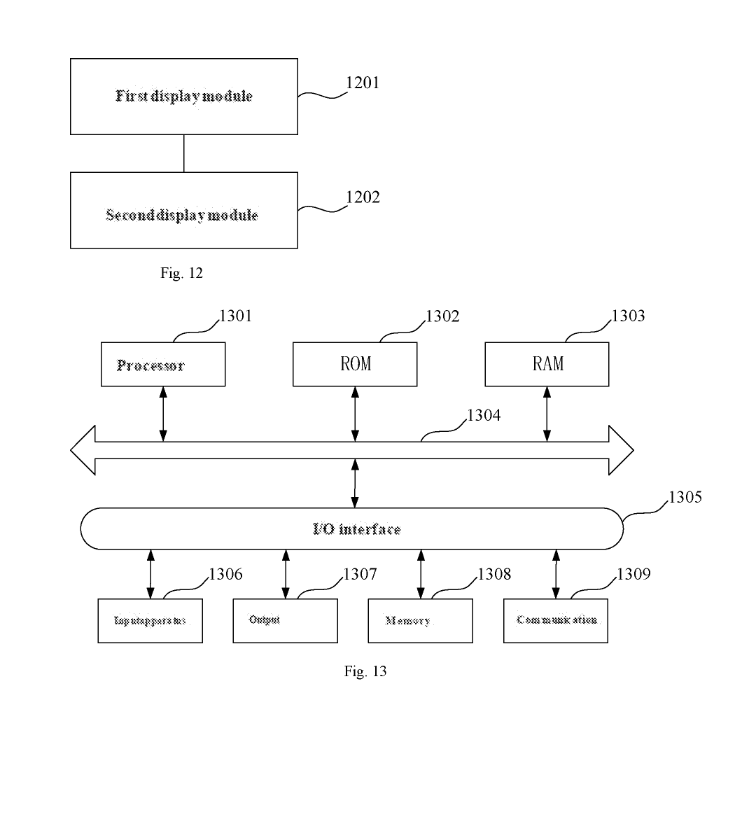

This embodiment provides an interaction apparatus, as shown in FIG. 12, the apparatus includes:
a first display module 1201, configured to display picture-text recommendation information and an interaction control on a first page, the picture-text recommendation information including at least one piece of recommendation picture-text, the interaction control being associated with an interactive animation and a target recommendation picture-text in the at least one piece of recommendation picture-text; and
a second display module 1202, configured to, in response to a trigger instruction for the interaction control, display the target recommendation picture-text on the first page, and superimpose and display the interactive animation on the target recommendation picture-text, the interactive animation being used to trigger display of recommendation content.

In some optional implementations, the interaction control includes a first progress bar in a first display style, the first page is further configured to display a second progress bar in a second display style, and the first progress bar and the second progress bar correspond to a position of the at least one piece of recommendation picture-text in the picture-text recommendation information.

In some optional implementations, the interaction control includes a movable control, and a trigger instruction of the movable control is generated based on moving the movable control from a first position to a second position, or generated based on moving the movable control in a preset direction.

In some optional implementations, the second display module 1202 includes:
a first generation unit, configured to, in a case where a trigger timing of the first progress bar is satisfied, generate a trigger instruction for the first progress bar; and
a first display unit, configured to, in response to the trigger instruction for the first progress bar, display the target recommendation picture-text on the first page, and superimpose and display the interactive animation on the target recommendation picture-text.

In some optional implementations, the trigger timing includes at least one of the following: display time of the picture-text recommendation information reaching a display timing of the target recommendation picture-text corresponding to the first progress bar; and detecting an interaction operation for the first progress bar.

In some optional implementations, the second display module 1202 includes:
a second generation unit, configured to, in response to a target interaction operation for the movable control, generate the trigger instruction for the movable control, the target interaction operation including moving the movable control from the first position to the second position, or moving the movable control in the preset direction; and
a second display unit, configured to, in response to the trigger instruction for the movable control, display the target recommendation picture-text on the first page, and superimpose and display the interactive animation on the target recommendation picture-text.

In some optional implementations, the second generation unit includes:

an instruction generation subunit, configured to, in response to the target interaction operation for the movable control, in a case where an interaction duration of the target interaction operation reaches a first preset duration, generate the trigger instruction for the movable control.

In some optional implementations, the interaction apparatus of the present disclosure further includes: in a case where a display duration of the interactive animation reaches a second preset duration and all interaction controls are triggered, switching the first progress bar in the interaction controls and the second progress bar in the first page to a third display style for display, and/or hiding the movable control in the interaction controls, a height of the first progress bar and a height of the second progress bar before switching being greater than a height corresponding to the third display style.

The interaction apparatus provided by the embodiments of the present disclosure may execute the interaction method provided by any embodiment of the present disclosure, and has corresponding functional modules and beneficial effects for executing the method.

Through the design of the interaction control, the interaction apparatus of the present disclosure may provide an interaction channel for interacting with the picture-text recommendation information to attract the user to interact with the interaction control. The target recommendation picture-text is displayed and the interactive animation is superimposed and displayed in response to the trigger instruction for the interaction control, therefore, the interactivity of the display of the picture-text recommendation information may be further improved by using the interactive animation, so as to improve the user interaction rate, which in turn helps to improve the trigger display of the recommendation content, thereby improving the recommendation effect of the recommendation content.

Further functional descriptions of each of the above modules and units are the same as the above corresponding embodiments, and will not be repeated here.

FIG. 13 is a structural block diagram of an electronic device provided by an embodiment of the present disclosure.

The following specifically refers to FIG. 13, which shows a structural block diagram of an electronic device suitable for implementing the embodiments of the present disclosure. The electronic device may include a processor (for example, a central processing unit, a graphics processor, etc.) 1301, which may perform various appropriate actions and processing according to a program stored in a read-only memory (ROM) 1302 or a program loaded from a memory 1308 into a random access memory (RAM) 1303. In the RAM 1303, various programs and data required for operations of the electronic device are also stored. The processor 1301, the ROM 1302, and the RAM 1303 are connected to each other through a bus 1304. An input/output (I/O) interface 1305 is also connected to the bus 1304.

Usually, the following apparatuses may be connected to the I/O interface 1305: an input apparatus 1306 including, for example, a touch screen, a touchpad, a keyboard, a mouse, a camera, a microphone, an accelerometer, a gyroscope, etc.; an output apparatus 1307 including, for example, a liquid crystal display (LCD), a speaker, a vibrator, etc.; a memory 1308 including, for example, a magnetic tape, a hard disk, etc.; and a communication apparatus 1309. The communication apparatus 1309 may allow the electronic device to perform wireless or wired communication with other devices to exchange data. Although FIG. 13 shows an electronic device with various apparatuses, it should be understood that it is not required to implement or have all the apparatuses shown, and alternatively, more or fewer apparatuses may be implemented or provided.

In particular, according to an embodiment of the present disclosure, the process described above with reference to the flowchart may be implemented as a computer software program. For example, an embodiment of the present disclosure includes a computer program product, which includes a computer program carried on a non-transitory computer-readable medium, where the computer program includes program codes for performing the method shown in the flowchart. In such an embodiment, the computer program may be downloaded and installed from a network through the communication apparatus 1309, or installed from the memory 1308, or installed from the ROM 1302. When the computer program is executed by the processor 1301, the above-mentioned functions defined in the interaction method of the embodiments of the present disclosure are executed.

The electronic device shown in FIG. 13 is only an example, and should not impose any limitation to the function and scope of use of the embodiments of the present disclosure.

An embodiment of the present disclosure further provides a computer-readable storage medium, the method according to the embodiments of the present disclosure described above may be implemented in hardware and firmware, or implemented as computer codes that may be recorded on a storage medium or originally stored in a remote storage medium or a non-transitory machine-readable storage medium and downloaded through a network and will be stored in a local storage medium, so that the method described herein may be processed by such software stored on the storage medium using a general-purpose computer, a special-purpose processor, or programmable or special-purpose hardware. The storage medium may be a magnetic disk, an optical disk, a read-only memory, a random access memory, a flash memory, a hard disk or a solid-state disk, etc. Further, the storage medium may also include a combination of the above-mentioned types of memories. It may be understood that the computer, the processor, the microprocessor controller or the programmable hardware includes a storage component that may store or receive software or computer codes, and when the software or computer codes are accessed and executed by the computer, the processor or the hardware, the interaction method shown in the above embodiments is implemented.

A portion of the present disclosure may be applied as a computer program product, such as computer program instructions, which, when executed by a computer, may invoke or provide the method and/or technical solutions according to the present disclosure through operations of the computer. Those skilled in the art should be able to understand that the computer program instructions exist in a computer-readable medium in a form including but not limited to a source file, an executable file, an installation package file, etc., and accordingly, the computer program instructions are executed by the computer in a manner including but not limited to: the computer directly executes the instructions, or the computer compiles the instructions and then executes a corresponding compiled program, or the computer reads and executes the instructions, or the computer reads and installs the instructions and then executes a corresponding installed program. Here, the computer-readable medium may be any available computer-readable storage medium or communication medium that may be accessed by the computer.

Although the embodiments of the present disclosure are described in combination with the drawings, those skilled in the art may make various modifications and variations without departing from the spirit and scope of the present disclosure, and such modifications and variations fall within the scope defined by the appended claims.

1. An interaction method, comprising:
displaying picture-text recommendation information and an interaction control on a first page, the picture-text recommendation information comprising at least one piece of recommendation picture-text, the interaction control being associated with an interactive animation and a first recommendation picture-text in the at least one piece of recommendation picture-text; and
in response to a trigger instruction for the interaction control, displaying the first recommendation picture-text on the first page, and superimposing and displaying the interactive animation on the first recommendation picture-text, the interactive animation being used to trigger display of recommendation content.

2. The method of claim 1, wherein the interaction control comprises a first progress bar in a first display style, the first page is further configured to display a second progress bar in a second display style; and
wherein the first progress bar and the second progress bar correspond to a position of the at least one piece of recommendation picture-text in the picture-text recommendation information.

3. The method of claim 1, wherein the interaction control comprises a movable control, and the trigger instruction of the movable control is generated based on moving the movable control from a first position to a second position, or generated based on moving the movable control in a preset direction.

4. The method of claim 2, wherein the displaying the first recommendation picture-text on the first page, and superimposing and displaying the interactive animation on the first recommendation picture-text in response to the trigger instruction for the interaction control comprises:
in a case wherein a trigger timing of the first progress bar is satisfied, generating a trigger instruction for the first progress bar; and
in response to the trigger instruction for the first progress bar, displaying the first recommendation picture-text on the first page, and superimposing and displaying the interactive animation on the first recommendation picture-text.

5. The method of claim 4, wherein the trigger timing comprises at least one of the following:
display time of the picture-text recommendation information reaching a display timing of the first recommendation picture-text corresponding to the first progress bar; and
detecting an interaction operation for the first progress bar.

6. The method of claim 3, wherein the displaying the first recommendation picture-text on the first page, and superimposing and displaying the interactive animation on the first recommendation picture-text in response to the trigger instruction for the interaction control comprises:
in response to a first interaction operation for the movable control, generating the trigger instruction for the movable control, the first interaction operation comprising moving the movable control from the first position to the second position, or moving the movable control in the preset direction; and
in response to the trigger instruction for the movable control, displaying the first recommendation picture-text on the first page, and superimposing and displaying the interactive animation on the first recommendation picture-text.

7. The method of claim 6, wherein the generating the trigger instruction for the movable control in response to the first interaction operation for the movable control comprises:
in response to the first interaction operation for the movable control, in a case wherein an interaction duration of the first interaction operation reaches a first preset duration, generating the trigger instruction for the movable control.

8. The method of claim 1, wherein the method further comprises:
in a case wherein a display duration of the interactive animation reaches a second preset duration and all interaction controls are triggered, switching a first progress bar in the interaction control and a second progress bar in the first page to a third display style for display, and/or hiding a movable control in the interaction control, a height of the first progress bar and a height of the second progress bar before the switching being greater than a height corresponding to the third display style.

9. The method of claim 1, wherein the interactive animation comprises an interactive control, the interactive control being used to trigger the display of the recommendation content, and the method further comprises:
in response to an interaction operation for the interactive control, displaying the recommendation content on a second page.

10. An electronic device, comprising:
at least one memory and at least one processor, the at least one memory and the at least one processor are communicatively connected to each other, the at least one memory stores computer instructions, and the at least one processor executes the computer instructions to implement an interaction method comprising:
displaying picture-text recommendation information and an interaction control on a first page, the picture-text recommendation information comprising at least one piece of recommendation picture-text, the interaction control being associated with an interactive animation and a first recommendation picture-text in the at least one piece of recommendation picture-text; and
in response to a trigger instruction for the interaction control, displaying the first recommendation picture-text on the first page, and superimposing and displaying the interactive animation on the first recommendation picture-text, the interactive animation being used to trigger display of recommendation content.

11. The electronic device of claim 10, wherein the interaction control comprises a first progress bar in a first display style, the first page is further configured to display a second progress bar in a second display style; and
wherein the first progress bar and the second progress bar correspond to a position of the at least one piece of recommendation picture-text in the picture-text recommendation information.

12. The electronic device of claim 10, wherein the interaction control comprises a movable control, and the trigger instruction of the movable control is generated based on moving the movable control from a first position to a second position, or generated based on moving the movable control in a preset direction.

13. The electronic device of claim 11, wherein the displaying the first recommendation picture-text on the first page, and superimposing and displaying the interactive animation on the first recommendation picture-text in response to the trigger instruction for the interaction control comprises:
in a case wherein a trigger timing of the first progress bar is satisfied, generating a trigger instruction for the first progress bar; and
in response to the trigger instruction for the first progress bar, displaying the first recommendation picture-text on the first page, and superimposing and displaying the interactive animation on the first recommendation picture-text.

14. The electronic device of claim 13, wherein the trigger timing comprises at least one of the following:
display time of the picture-text recommendation information reaching a display timing of the first recommendation picture-text corresponding to the first progress bar; and
detecting an interaction operation for the first progress bar.

15. A non-transitory computer-readable storage medium, wherein the non-transitory computer-readable storage medium stores computer instructions, the computer instructions, when executed by a computer, cause the computer to implement an interaction method comprising:
displaying picture-text recommendation information and an interaction control on a first page, the picture-text recommendation information comprising at least one piece of recommendation picture-text, the interaction control being associated with an interactive animation and a first recommendation picture-text in the at least one piece of recommendation picture-text; and
in response to a trigger instruction for the interaction control, displaying the first recommendation picture-text on the first page, and superimposing and displaying the interactive animation on the first recommendation picture-text, the interactive animation being used to trigger display of recommendation content.

16. The non-transitory computer-readable storage medium of claim 15, wherein the interaction control comprises a first progress bar in a first display style, the first page is further configured to display a second progress bar in a second display style; and
wherein the first progress bar and the second progress bar correspond to a position of the at least one piece of recommendation picture-text in the picture-text recommendation information.

17. The non-transitory computer-readable storage medium of claim 15, wherein the interaction control comprises a movable control, and the trigger instruction of the movable control is generated based on moving the movable control from a first position to a second position, or generated based on moving the movable control in a preset direction.

18. The non-transitory computer-readable storage medium of claim 16, wherein the displaying the first recommendation picture-text on the first page, and superimposing and displaying the interactive animation on the first recommendation picture-text in response to the trigger instruction for the interaction control comprises:
in a case wherein a trigger timing of the first progress bar is satisfied, generating a trigger instruction for the first progress bar; and
in response to the trigger instruction for the first progress bar, displaying the first recommendation picture-text on the first page, and superimposing and displaying the interactive animation on the first recommendation picture-text.

19. The non-transitory computer-readable storage medium of claim 18, wherein the trigger timing comprises at least one of the following:
display time of the picture-text recommendation information reaching a display timing of the first recommendation picture-text corresponding to the first progress bar; and
detecting an interaction operation for the first progress bar.

20. The non-transitory computer-readable storage medium of claim 17, wherein the displaying the first recommendation picture-text on the first page, and superimposing and displaying the interactive animation on the first recommendation picture-text in response to the trigger instruction for the interaction control comprises:
in response to a first interaction operation for the movable control, generating the trigger instruction for the movable control, the first interaction operation comprising moving the movable control from the first position to the second position, or moving the movable control in the preset direction; and
in response to the trigger instruction for the movable control, displaying the first recommendation picture-text on the first page, and superimposing and displaying the interactive animation on the first recommendation picture-text.
